(19) United States
(12) Patent Application Publication
(10) Pub. No.: US 2022/0101094 A1
(43) Pub. Date: Mar. 31, 2022

(54) SYSTEM AND METHOD OF CONFIGURING A SMART ASSISTANT FOR DOMAIN SPECIFIC SELF-SERVICE SMART FAQ AGENTS

(71) Applicant: Infosys Limited, Bangalore (IN)

(72) Inventors: Amit Kumar, Hyderabad (IN); Dharmendra Choudhary, Jodhpur (IN); Ganta Ravi Raja, Nellore (IN); Abhisek Panigrahi, Bengaluru (IN)

(21) Appl. No.: 17/344,061

(22) Filed: Jun. 10, 2021

(30) Foreign Application Priority Data
Sep. 30, 2020 (IN) 202041042613

(51) Int. Cl. G06N 3/04; G06N 3/08; G06F 3/14; G06F 40/30; G06F 40/205

(52) U.S. Cl. CPC G06N 3/0427; G06N 3/084; G06F 40/205; G06F 40/30; G06F 3/14

(57) ABSTRACT

A computer aided method of configuring a smart assistant for domain specific self-service; comprising receiving, through a user interface, a predefined domain specific dataset; generating, by a training engine, a set of positive and negative samples in equal ratio; validating the predefined dataset to remove a set of ambiguous data entries; indicating, a numerical representation and a query representation for the predefined dataset; creating a Domain representation using multiple connected layers and use it to process FAQ to understand the best contextual representation; identifying, an accuracy of the configured model by matching with ground truth labels and assigning a confidence score to each entry in the predefined domain specific dataset by creating a Domain representation using multiple connected layers and use it to process FAQ to understand the best contextual representation.

This application claims the benefit of Indian Patent Application Serial No. 202041042613 filed Sep. 30, 2020, which is hereby incorporated by reference in its entirety.

### FIELD

A system and method of configuring a smart assistant for domain specific self-service smart FAQ agents.

### BACKGROUND

Intelligent & Smart assistants work as bridge between Human computer interactions, but it lacks domain intelligence. it works great with limited numbers of pre-defined static intents and rules and Entities.

Some online services create large collections of questions and their corresponding answers. These Question and Answers (Q&A) services may provide traditional frequently Asked Question (FAQ) services or may provide services in which SMEs contribute both questions and answers to those questions. These Q&A services provide a mechanism allowing users to search for previously presented answers to previously posed questions. These Q&A services typically input a queried question from a user, identify questions of the collection that relate to the queried question (i.e., a question search), and return the answers to the identified questions as the answer to the queried question.

Such Q&A services typically treat questions as plain text. The Q&A services may use various techniques including a vector space model and a language model when performing a question search. Such Q&A services may identify questions as being related to queried question. However, the Q&A services may be unable to determine, most related question to the queried question. The Q&A services provide a ranking of the closeness of the identified questions to the queried questions. Such a ranking may represent the queried question and each identified question as a feature vector of keywords. The closeness of an identified question to the queried question is based on the closeness of their feature vectors. The closeness of the feature vectors may be determined using, for example, a cosine similarity metric.

Some Q&A systems present questions that are relevant to a queried question based on clusters of topics and clusters of focuses of the questions is provided by them. A question search system provides a collection of questions. Each question of the collection has an associated topic and focus. Upon receiving a queried question, the question search system identifies questions of the collection that may be relevant to the queried question and generates a score or ranking indicating relevance of the identified questions. The question search system clusters the identified questions into topic clusters of questions with similar topics. The question search system may also cluster the questions within each topic cluster into focus clusters of questions with similar focuses.

FAQ Knowledge Automation is an AI based Module which helps user to automate their domain knowledge sources (in Question Answers format) and helps user to get the best Contextual Semantic interpretation of Questions along with the Answers. FAQ Knowledge Automation creates Domain Representation internally to learn the domain specific context. It uses Multiple Domain specific settings and configuration, Visualization to train and inference it.

Most of these Systems are not very good at understanding domain specific language context and fail to understand domain specific FAQ. The need for a system and method for configuring a smart assistant for domain specific self-service is deeply felt.

### SUMMARY

Systems and methods for creating Domain specific smart FAQ agents are provided.

System creates a Domain representation using multiple connected layers and use it to process FAQ to understand the best contextual representation.

Once the embeddings are calculated for Domain Data, System then pass them through the Deep connected layers which learns the dependency between words and across all the Domain Data inputs to create the Domain Representations

During inference, a query from user is received and the relevant Domain FAQ to user's query needs to be found. The pre-trained model to calculate representation for the User's query is used and then passed through the pre-trained neural network layers to find the similarity. Once the relevancy scores of each of the domain data is calculated, the top 5 scores are filtered out. After post-processing which involves fine tuning of scores with the help of cosine score calculations using Domain Representations and based on the scores the answer related to that domain question and return to the user is fetched.

A computer aided method of configuring a smart assistant for domain specific self-service is described which comprises of receiving a predefined domain specific dataset through a user interface. The predefined domain specific dataset is validated to remove a set of ambiguous data entries. A numerical representation for the predefined domain specific dataset is generated. The numerical representation for predefined domain specific dataset is parsed using a machine learning model for learning semantic relationships by optimizing error between a predicted and a preset ground truth label. An identification of an accuracy level of the machine learning model is performed by matching the predicted and the preset ground truth label on the predefined domain specific dataset. Subsequently a confidence score is assigned to each entry in the predefined domain specific dataset based on a set of existing FAQs by using the machine learning model and a second set of ranked domain specific dataset based on the confidence score is presented to the end user.

The predefined domain specific dataset comprises a set of unique FAQ data related to a specific domain and a set of positive and negative samples in equal ratio, is generated by a training engine, from the predefined domain specific dataset.

The validation 500 comprises, matching the similarity of the data within the predefined domain specific dataset and the accuracy of the configured model is calculated based on matching the predicted and the preset ground truth label on the predefined domain specific dataset.

A confidence score is assigned to each entry in the predefined domain specific dataset based on a prediction score from the learned model and a similarity score for each entry in the predefined domain specific dataset.

### BRIEF DESCRIPTION OF THE DRAWINGS

The embodiments of this invention are illustrated by way of example and not limitation in the figures of the accompanying drawings, in which like references indicate similar elements and in which:

FIG. 1 is block diagram of an embodiment of an exemplary computing system for configuring a smart assistant for domain specific self-service.

FIG. 2 is a schematic block diagram illustrating the structure of a computer system on which methods of the invention may be embodied.

FIG. 3 describes the data collection process.

FIG. 4 describes the data creation process.

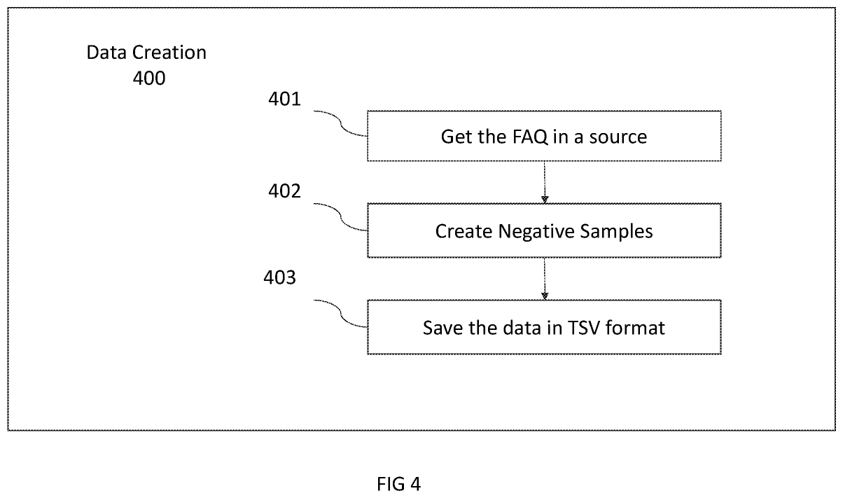

FIG. 5 describes the data visualization process.

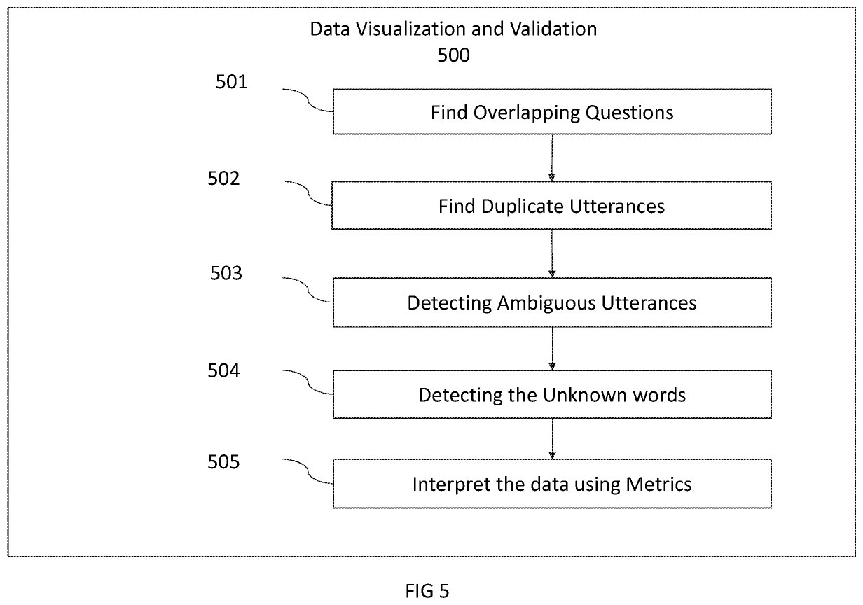

FIG. 6 describes the overall Domain Training process.

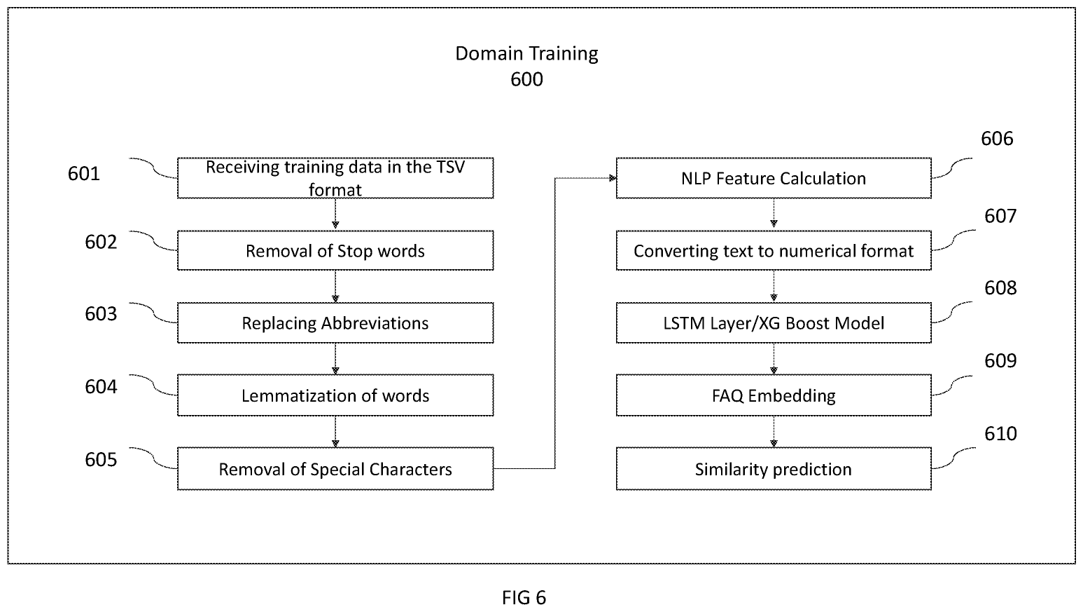

### DETAILED DESCRIPTION

Exemplifying embodiments, as described below, may be used to provide a method, an apparatus and/or a system of configuring a smart assistant for domain specific self-service.

Although the present embodiments have been described with reference to specific example embodiments, it will be evident that various modifications and changes may be made to these embodiments without departing from the broader spirit and scope of the various embodiments.

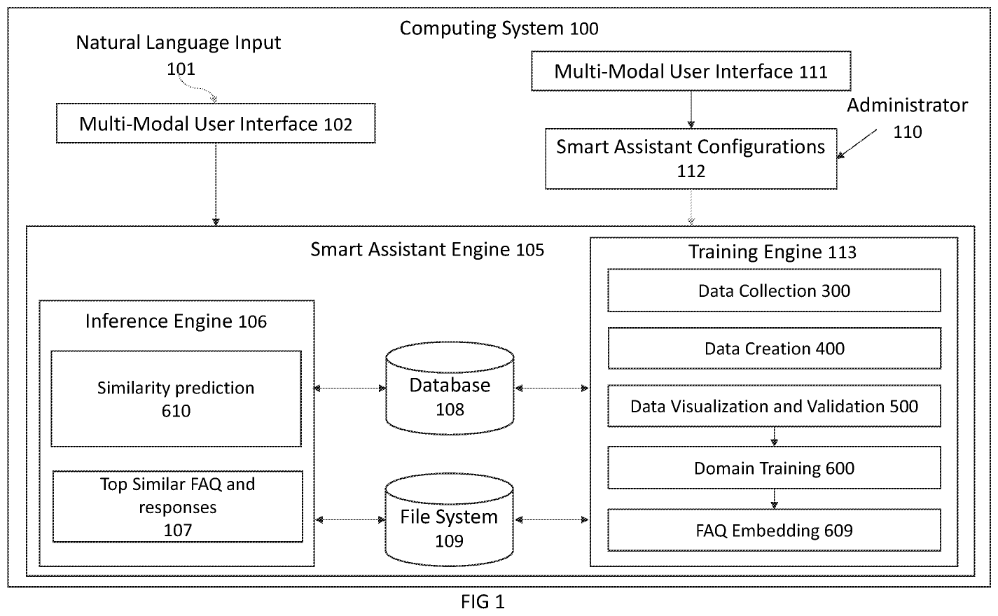

FIG. 1 is block diagram of an embodiment of an exemplary computing system for configuring a smart assistant for domain specific self-service. In one embodiment, a computing system 100 receives a natural language query User input 101 through a multi—modal user interface 102. The multi—modal user interface 102 may be a User Interface (UI) component where user can input user queries and the response results may be displayed. The UI component may be custom for the framework or may be an integration of the existing components available. For example Skype, Messenger, Custom web channel and voice based setups such as Alexa, Google home, Siri etc. or may be specially designed for use with the computing system 100.

In one embodiment, 110 may be an administrator (admin) or an SME who develops/trains a domain specific hot. The administrator is provided with a second multi modal user interface (UI) 111. The second multi-modal UI may be referred as a hot studio, where admin can develop/train. hots for different domains. The admin may perform smart assistant configuration 112 by using various option used during configuration of domain hot. The various options may include, but not limited to, language of hot, domain of hot, training settings etc. In respect of the invention described herein, the terms domain specific FAQ and smart FAQ and associated terms are used interchangeably through the description.

In one embodiment, an Inference Engine 106 is configured to generate the list of top similar FAQs and their answers for a given user query in the form of the natural language query input 101. The Inference Engine 106 is configured to use a trained model based on the domain training provided 600 and domain FAQ embedding 609 for preconfigured FAQs to find top similar FAQs. Based on top model scores, top similar FAQs may be returned as response 107.

In one embodiment Smart Assistant Engine 105 may comprise Inference Engine 106 and a training engine 113 coupled to a database 108 and a storage file system 105.

In one embodiment the training steps of smart assistant configuration 112 and training the engine113 may be executed before receiving the user input 101. The inference engine 106 may use trained model and embedding from the training engine 113 The top similar FAQ and responses 107 will be json object containing FAQs and their corresponding similarity scores ordered by similarity scores. Number of responses can be 0 to 5 depending on similarity scores.

In one embodiment, a Training Engine 113 is configured for training a new domain specific smart assistant. An example of a new domain can be HR policy domain, where list of Policy FAQs can be configured and employees can get their queries answered using preconfigured FAQs or Bank domain where customers can get their queries answered using similar FAQs. The Training Engine is configured for domain training and data collection 300, data creation 400, data visualization and validation 500 and domain training 600. FAQ embedding 609 is generated as an output from the training engine and stored along with trained model in a file system.

In one embodiment data collection may comprise adding Questions, answers and utterances.

In one embodiment, a set of configurations 112 for smart assistant training and inference are provided as input to administrator 110 for tuning smart assistant specific to their respective domain use cases and generating a domain specific smart assistants using Multi-Modal user interface 111. A UI window may be used for providing and configuring language of bot, domain of bot, how many similar FAQs to return as response, domain keywords etc.

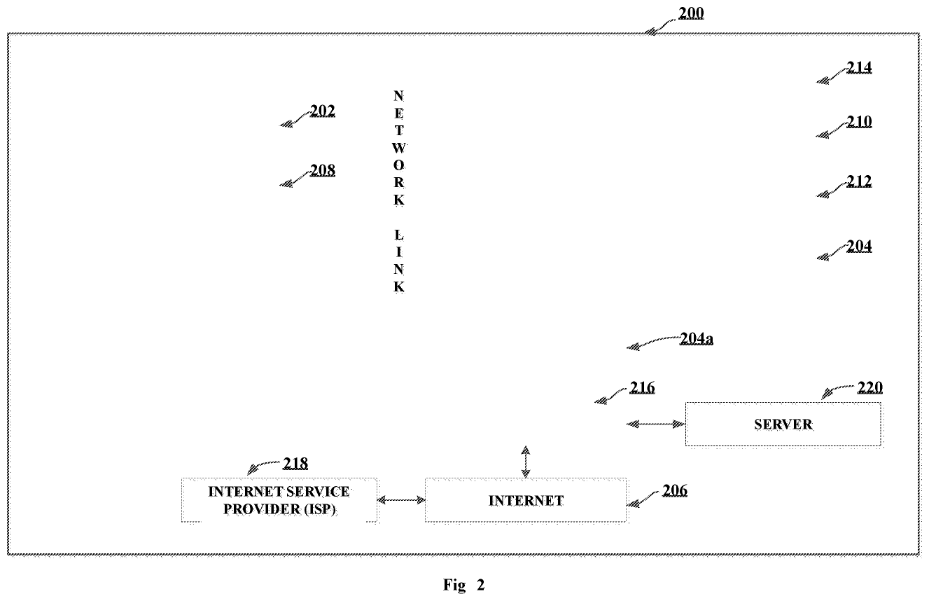

FIG. 2 is a block diagram of a computing device 200 to which the present disclosure may be applied according to an embodiment of the present disclosure. The system includes at least one processor 202, designed to process instructions, for example computer readable instructions (i.e., code) stored on a storage device 104. By processing instructions, processing device 202 may perform the steps and functions disclosed herein. Storage device 204 may be any type of storage device, for example, but not limited to an optical storage device, a magnetic storage device, a solid state storage device and a non-transitory storage device. The storage device 204 may contain software 204a which is a set of instructions (i.e. code). Alternatively, instructions may be stored in one or more remote storage devices, for example storage devices accessed over a network or the interne 206. The computing device also includes an operating system and microinstruction code. The various processes and functions described herein may either be part of the microinstruction code or part of the program (or combination thereof) which is executed via the operating system. Computing device 200 additionally may have memory 208, an input controller 210, and an output controller 212 and communication controller 214. A bus (not shown) may operatively couple components of computing device 200, including processor 202, memory 208, storage device 204, input controller 210, output controller 212, and any other devices (e.g., network controllers, sound controllers, etc.). Output controller 212 may be operatively coupled (e.g., via a wired or wireless connection) to a display device (e.g., a monitor, television, mobile device screen, touch-display, etc.) in such a fashion that output controller 212 can transform the display on display device (e.g., in response to modules executed). Input controller 210 may be operatively coupled (e.g., via a wired or wireless connection) to input device (e.g., mouse, keyboard, touch-pad, scroll-ball, touch-display, etc.) in such a fashion that input can be received from a user. The communication controller 214 is coupled to a bus (not shown) and provides a two-way coupling through a network link to the internet 206 that is connected to a local network 216 and operated by an internet service provider (hereinafter referred to as ‘ISP’) 218 which provides data communication services to the internet. Network link typically provides data communication through one or more networks to other data devices. For example, network link may provide a connection through local network 216 to a host computer, to data equipment operated by an ISP 118. A server 220 may transmit a requested code for an application through internet 206, ISP 218, local network 216 and communication controller 214. Of course, FIG. 2 illustrates computing device 200 with all components as separate devices for ease of identification only. Each of the components may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 200 may be one or more servers, for example a farm of networked servers, a clustered server environment, or a cloud network of computing devices.

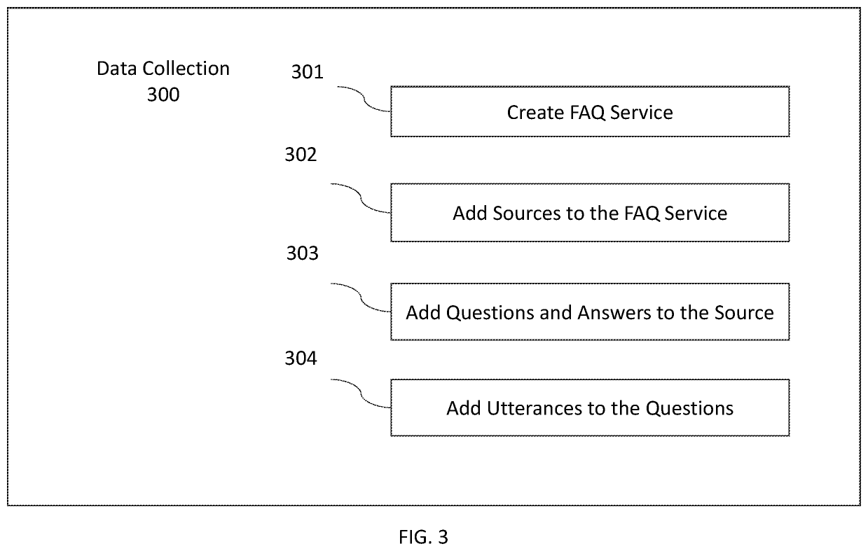

In another embodiment, FIG. 3 describes a simplified flow diagram of a method for generating FAQ data. Generation of FAQ data includes creation of FAQ

Service 301 using the processing device 202. Many bots can be linked to a common FAQ Service. Linking the bot to FAQ Service is a kind of many-to-one relationship. Many bots can have same FAQ service linked. Outcome is that when a FAQ service is linked to a bot, that bot can answer the questions related to that FAQ service. If not linked, then that bot cannot answer since it is not aware of that FAQ service and the associated context. Same FAQ service may be used across different channels. For example, on skype and messenger. Same service can be used in 2 different bots for example one is for employee and one is for customers etc.

Each FAQ Service consists of one or more than one Sources 302. For example, FAQ service is related to Food Delivery, then the sources can be Order, Status, Menu etc. FAQ Service may be created 301 as either a blank service or through importing a pre-existing service. The service may be edited to provide a custom name while choosing the service as blank or by editing the imported pre-existing service.

For an imported FAQ service, all the sources, Questions & Answers, and utterances are auto populated. A user/admin may have the option of modifying the parameters populated from the imported FAQ service. Pre-existing service may be a service which was created previously from blank, but same service is to be used in another deployment or in another bot. Such service can be exported and imported in another place.

In another embodiment, an FAQ Source 302 consists of a list of FAQs which are contextually related to each other. For instance, if the FAQ Service is related to Food Delivery, FAQ. Sources can be Order, Status, Menu etc. FAQ Source may also be created either by importing an existing source or creating a blank one.

The FAQ source may be edited to provide a custom name while choosing the service as blank or by editing the imported pre-existing service. For an imported FAQ service, all the sources, Q&A, and utterances are auto populated. A user/admin may have the option of modifying the parameters populated from the imported FAQ service.

In another embodiment FAQ Q&A, comprises of relevant contextual Questions and Answers pairs 303 relevant to a selected domain. Question and answer pairs are selected for inclusion in the FAQ source based on the various values in conjunction with parameters supplied by an administrator.

In one more embodiment, FAQ Utterances 304 includes a user communication of input words or phrases relevant to a frequently asked question (FAQ). Each question can be asked in different ways based on a user submitting his query. While creating the FAQ, utterances for each of the question and answers is also added. In order to understand the question better, utterances need to be added. Utterances can be added either manually or uploading a text file where question and utterances are separated by tabs and are identifiable by spreadsheet or a similar tool. Answer is used when a user query is received, instead returning top questions will return the answer directly.

In an exemplary embodiment, in order to generate a model which can distinguish between a cat and dog, the model needs to be trained on data for both cats and dogs. Training only on cats may not help the model to distinguish one from the another. Similarly, the FAQ model is trained to identify if two FAQs are similar or not. In order to achieve this similar FAQ pairs are referred to positive example and non-similar FAQ pairs are referred to negative example.

In another embodiment FAQ Training engine 113 uses data creation algorithm which ensures Domain specific balanced training set auto created using configured knowledge source by creating positive and negative samples in equal ratio.

Configured knowledge source may be a list of configured FAQs, utterances and their answers

In an exemplary embodiment, if there let us consider data of 1000 images of dogs and cats and 990 of them are cats and 10 are dogs, then this data is imbalanced. Training the model on this kind of data is not useful as the data is biased towards cats. Similarly, training the model on biased data will create a biased model.

In order to overcome this anomaly, the training engine is configured to create the dataset of positive and negative instances in the ratio of 50:50 so that the model trained is unbiased. Positive examples are created using FAQ and its utterance configured by admin 401. For negative examples, we compare one paraphrase from one FAQ to other Master FAQs 402. Once the negative samples are created using the heuristic mentioned above, the data is saved in a tab separated text file format like, but not limited to .tsv format containing (question1, question2, similarity) 403.

In another embodiment, utterances of a master FAQs are required to be both verbally and contextually different so that the model can learn more about the semantic semantics of language used in FAQ and context of words used in FAQ information of the FAQ. Adding a single extra word or modifying only a word or two in the query and adding them as an utterance is not useful. The dataset created in this way is redundant and does not add much value. There can be situations where user can add two different master FAQs which are practically same.

In another embodiment a visualization tool helps in identifying Overlapping FAQs 501, duplicate utterances 501, ambiguous utterances 503, unknown words 504 and also some metric information 505 like number of utterances per Master FAQ, number of words in all FAQs. The validation comprises, matching the similarity of the data within the predefined domain specific dataset and the accuracy of the configured model is calculated based on matching the predicted and the preset ground truth label on the predefined domain specific dataset. The visualization tool can be any existing tool and not limiting to the form and structure as to be configured specially for the purposed specified in this invention.

In another embodiment, utterances of other master FAQs or master FAQs itself can overlap and have the same set of words with only a small variation.

User could have added a new master FAQ unaware of the similar FAQ which is already present in the data. For example, creating 2 master FAQs which are similar and have same answer, but are treated as separate FAQs. For example, Master FAQ1—How many earned leaves will I get? Master FAQ2—How many leaves will be credited as earned leave? User could have added a new master FAQ unaware of the similar FAQ which is already present in the data.

In another embodiment, Before the training the user is presented with all these metrics so that user can modify the data. This can be achieved by using distance metric called cosine similarity which gives a score between 0 to 1. (1 indicating FAQs contain same words and similar to each other and 0 indicating otherwise.) However, Cosine similarity doesn't take into consideration the context information of the FAQs, Whereas, the deep learning based model learns the domain specific context information and works for the queries which contains words which are semantically similar. Cosine will fail in this case.

Example 1: In an exemplifying embodiment where there are 2 different Master FAQs but almost Similar Alternative utterances—been added to train the Model

| Master Question | Alternate Question | Recommendation |
|---|---|---|
| If twins are born, | What if multiple | If you closely watch almost |
| then how many days | babies are born in | similar utterances -it's been |
| of paternity leaves | one delivery? | added for 2 different Master |
| will be granted? | | FAQs, which creates |
| If twins are born, | What if multiple | Ambiguity and hence affects |
| then how many days | child are born in | the Model Prediction. Always |
| of maternity leaves | one delivery? | try to add different utterances |
| will be granted? | | to different Master FAQs. |

The utterances within a master FAQ can also be duplicate. Having a word or two difference (or) rephrasing the sentence with same words does not add much value to the data. So with the help of cosine similarity will be identify all the utterances which are 90% or more similar.

A user can add a completely different utterance which is not related to master FAQ. This can lead to confusion while training the model. Hence the training engine is configured to find all the utterances which do not match at least 40% of the master FAQ.

In one more embodiment pre-trained word Glove is used for embedding vectors called Glove. But the Glove also does not contain each and every word. Some words (or) abbreviations can be specific to a particular domain. For instance, WFH, OD, CCD etc. All the words which are missing in Glove are found and shown to the userso that they can add abbreviations of that words.

In another embodiment, metrics used may comprises of number of utterances for each FAQ (helps in identifying the FAQs having no utterances), number of words in all FAQs (helping in identifying the utterances which are very long. In general chat bot scenario, no one will ask length question consisting of 3 or more sentences.), Past Analysis (which will show a overview of all the FAQ data). With the help of visualization, the model is better trained by removing/modifying all the outliers and thus given higher accuracies on domain specific training.

In another embodiment, in order to predict the semantic similarity of two FAQ's, a model needs to be trained. Machine learning models take only numerical input. So the data is converted to numerical format. Before converting the data to numerical format various data cleaning and data normalization steps are performed to make it consistent for training the model.

In another embodiment, the domain training and fine tuning of the data is performed. The model is trained when the training request is received 601 along with some configurations and training data, which is in the format of tsv file. The tsv file contains data in the format <id> <qid1> <qid2> <question1> <question2> <similarity>. Id is a numerical value indicating each row. Qid is in the format <masterid> <childid>. Utterances of same master question may have the same master-id but different child-id. Similarity can be 0/1.

In another embodiment, and as mentioned above there are certain configurations which will be received during the training process. Every domain FAQ data is unique, fixed model pipeline or configurations might not give best result for that particular domain data. So we have exposed few configurations for fine-tuning pipeline. Users can tune model using hyper parameters such as stop words removal 602, replacing Abbreviations 603, lemmatization of words 604, Removal of Special Characters 605 describe those configurations.

In another embodiment, Stop words are the words which occur frequently in a particular language. For instance, in English, stop words could be like: a, an, the, is, are, am, that, etc. Removing stop words from the sentences improves accuracy for some datasets. Stop words are provided as a configuration to be able to try different configurations and find out which configuration will be better for training the model on the given data.

In another embodiment, many domain specific words/abbreviations like WFH, CCD etc. have domain specific meanings. In order to handle the abbreviations and missing words, Administrator can configure domain specific vocabulary and abbreviations. If the replace abbreviations configuration is enabled the abbreviations will be replaced with its corresponding expanded forms.

In another embodiment, Lemmatization is the process of grouping together the different inflected forms of a word so they can be analyzed as a single item. Examples of lemmatization:

Rocks—>Rock

Corpora—>Corpus

Better—>Good

With lemmatization different words and their root forms can be grouped together.

In another embodiment, a user might ask query in a completely different language (or) can add some garbage characters in questions/utterances. In the data cleaning process, any special characters which are not present in that language are removed.

Semantic features from the pair of questions are extracted using some known NLP techniques 606. Some NLP Features may comprise Count Features, TFIDF features, Fuzzy matching features, Sentence Similarity Features such as Cosine etc.

In another embodiment, once the data is cleaned it can be converted into numerical representation which can be used by models. The numerical representation is parsed for predefined domain specific dataset using a machine learning model for learning semantic relationships by optimizing error between a predicted and a preset ground truth label.

In one embodiment, any machine learning model will only take numbers as input. So the text data needs to be converted into numerical form. There are a number of ways through which It can be done:
1. Maintain a dictionary of words each assigned to a unique id and replace the word with its id
2. Maintain a dictionary of words and have a vector of Booleans indicating whether a word is present in the sentence or not

Above mentioned are only a few illustrative examples and may not be construed to be limiting. The numerical representation is parsed for the model to learn semantic relationships Word embedding are a way of representing the words in a vector which contains contextual information. Briefly, word embedding algorithms are trained on huge amount of data where the model is trained to predict a word given the context. due to training this algorithm on a significant amount of data for a significant amount of time the vector representation of the word contains contextual information.

Pre-trained word embedding vectors (Glove) are used in the use case. 607. In another embodiment, combining the word embeddings and a set of features calculated, the sentences are converted into numerical form which thus can be passed as input to the model. As the size of dataset increases, calculation of features becomes time consuming. A configuration whether or not to calculate the features is used. With more data, deep learning models start performing better and even removing need of such features calculations. This option allows creation of robust domain specific pipeline from small source containing 5 FAQs to large source containing 1000 or even 10000 FAQs. The model takes FAQs as input and aims at finding the relevancy between these FAQs.

In another embodiment, once the embeddings are calculated for FAQ Data, they are passed through the LSTM layer 608 which learns the dependency between words and across all the FAQ inputs 608. The representations given by LSTM are termed as FAQ Embedding 609. The relevancy between these two FAQs are calculated by calculating the difference between the representations, and spatial distance (by multiplying the representations). The two forms along with the representations given by LSTM are concatenated for further training the model and fine-tuning FAQ Embedding.

In one embodiment, normalization and outlier removal is performed using batch normalization Technique. To make the Model robust, some noise is added (Gaussian Noise), instead of training the model only with the provided FAQ data some disturbances to the data is added. Then pass through a Fully connected network (which is simple feed forward neural network layer which takes input in certain dimension and reduces to lower dimension or vice versa.). A dropout layer is added (which randomly removes the neural connections in the network), by adding this dropout layer the model will not overfit on the data and learns how to utilize information from all the input points. Finally, fully connected network will output a single value ranging from 0 to 1. (0 indicating the given inputs are irrelevant and 1 indicating the inputs are relevant).

In another embodiment, based on the predicted score and actual label, the model is trained by back propagating error and updating weight parameters. Once the model is trained, the it can now be used for predicting whether the given two FAQ Queries are relevant to each other or not.

In another embodiment, the model is trained to predict two FAQs are similar or not 610, but as byproduct of training this model, FAQ Embeddings 609 are created, which contains the domain specific contextual information. Performing a cosine similarity using these FAQ embeddings leads to predicting the similarity of the FAQs with a decent accuracy. LSTM layers are shared with both FAQs during training, which reduce number of training parameters and hence reducing requirement of huge data. Shared weights LSTM layers help the model in learning good FAQ Embedding representation with richer contextual information. Same concept enables to perform faster inference

In another embodiment, the FAQ Model is trained using ML algorithm such as random forest and XGBoost also by using feature calculation mentioned in data preprocessing section.

In another embodiment, once during inference, a query is received from user and relevant FAQ need to be derived to user's query. One simple way to do inference is for each of FAQ and FAQ paraphrases present in the dataset, calculate the relevancy with the user's input and return the FAQs which are having high scores. But there is an overhead here. Finding relevancy with respect to master FAQ is sufficient rather doing on all of its paraphrases/utterances. This will save a lots of computation. For example, there are 10 master questions and each having 5 utterances. So the final dataset will have 50 unique FAQs (master and paraphrase both). So instead of comparing with 80 FAQs only 10 master FAQs are to be compared.

In another embodiment, it is described how to optimize the model for inference. In deep learning model there are 2 inputs. The input 1 depends on input 2 while calculating the difference and spatial distance of FAQ Embeddings. Prior to that, calculating the FAQ Embeddings is independent of another input. So after the training is done, FAQ embeddings will be saved for all the master FAQs. During inference, the FAQ Embedding of only user's query are calculated instead of both the inputs, which will reduce the call to computational heavy LSTM layer to 1.

In another embodiment, there can be the cases where user can ask the exact same query. So instead of calculating the FAQ Embeddings and processing through multiple neural network layers and predicting the relevancy score, as an optimization static match configuration is provided, which if configured will first search in the FAQ master and utterances data whether exact same FAQ or query is present or not. If present, it will return the relevant master question with confidence score of 1.0 and the confidence score is assigned to each entry in the predefined domain specific dataset. If not present the score will be different and in such a scenario it is passed through the resultant trained model to predict. As the string matching on a million sentences will be performed under a second, this configuration can be useful in some cases.

In another embodiment, once the relevancy scores of each of the master question is calculated, the top 5 scores are filtered out. After performing some post-processing which comprising fine tuning of scores with the help of cosine score calculations using FAQ Embeddings. Based on the scores, if the top score is greater than 0.9 the model will fetch the answer related to that master question and present it to the user. If the score is in between 0.4 and 0.9 the user will be shown the top 3 queries and the user will be asked to pick the relevant question related to their query.

If the top score is less than 0.4 the model will prompt the user to reframe the query. All these scores are configurable. The queries whose scores are falling in between 0.4 to 0.9 will further can be used for fine-tuning the model.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). The medium may be, for example, a memory, a transportable medium such as a CD, a DVD, or a portable memory device. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Moreover, as disclosed herein, the term “computer-readable medium” includes, but is not limited to portable or fixed storage devices, optical storage devices and various other mediums capable of storing, or containing data.

Accordingly, the specification and drawings are to be regarded in an illustrative rather than a restrictive sense.

Terms and phrases used in this document, and variations thereof, unless otherwise expressly stated, should be construed as open ended as opposed to limiting.

As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer implemented method of configuring a smart assistant for domain specific self-service, comprising:
receiving, through a multi modal user interface, a predefined domain specific dataset;
validating the predefined domain specific dataset to remove a set of ambiguous data entries;
generating a numerical representation for the predefined domain specific dataset;
parsing the numerical representation for predefined domain specific dataset using a machine learning model for learning semantic relationships by optimizing error between a predicted and a preset ground truth label;
identifying an accuracy level of the machine learning model by matching the predicted and the preset ground truth label on the predefined domain specific dataset;
assigning a confidence score to each entry in the predefined domain specific dataset based on a set of existing FAQs by using the machine learning model; and
presenting, through the multi modal user interface, a second set of ranked domain specific dataset based on the confidence score.

2. The method of claim 1 wherein the predefined domain specific dataset comprises a set of unique FAQ data related to a specific domain.

3. The method of claim 1, wherein a set of positive and negative samples in equal ratio, is generated by a training engine, from the predefined domain specific dataset.

4. The method of claim 1, wherein the validation comprises, matching the similarity of the data within the predefined domain specific dataset.

5. The method of claim 1, wherein the accuracy of the configured model is calculated based on matching the predicted and the preset ground truth label on the predefined domain specific dataset.

6. The method of claim 1, wherein assigning a confidence score to each entry in the predefined domain specific dataset is performed based on a prediction score from the learned model and a similarity score for each entry in the predefined domain specific dataset.

7. A system for configuring a smart assistant for domain specific self-service comprising:
a processor; and
a memory coupled to the processor configured to be capable of executing programmed instructions comprising and stored in the memory to:
receive, through a multi modal user interface, a predefined domain specific dataset;
validate the predefined domain specific dataset to remove a set of ambiguous data entries;
generating, a numerical representation and a query representation for the predefined dataset;
parse the predefined domain specific dataset through a set of fully connected layers for back propagating loss between a predicted and a preset ground truth label;
identify, an accuracy of the configured model by discarding a set of ambiguous or duplicate data entries; and
assign a confidence score to each entry in the predefined domain specific dataset; and
presenting, through the multi modal user interface, a second set of ranked domain specific dataset based on the confidence score.

8. The system of claim 7 wherein the predefined domain specific dataset comprises set of unique FAQ data related to the specific domain.

9. The system of claim 7, wherein a set of positive and negative samples in equal ratio, is generated by a training engine, from the predefined domain specific dataset.

10. The system of claim 7, wherein the validation comprises, similarity matching within the predefined domain specific dataset.

11. The system of claim 7, wherein the accuracy of the configured model is calculated based on matching the predicted and the preset ground truth label on the predefined domain specific dataset.

12. The system of claim 7, wherein assigning a confidence score to each entry in the predefined domain specific dataset is performed based on a prediction score from the learned model and a similarity score for each entry in the predefined domain specific dataset.

13. At least one non-transitory computer-readable medium storing computer-readable instructions that, when executed by one or more computing devices, cause at least one of the one or more computing devices to:
receive, through a multi modal user interface, a predefined domain specific dataset;
validate the predefined domain specific dataset to remove a set of ambiguous data entries;
generating, a numerical representation and a query representation for the predefined dataset;
parse the predefined domain specific dataset through a set of fully connected layers for back propagating loss between a predicted and a preset ground truth label;
identify, an accuracy of the configured model by discarding a set of ambiguous or duplicate data entries; and
assign a confidence score to each entry in the predefined domain specific dataset; and
presenting, through the multi modal user interface, a second set of ranked domain specific dataset based on the confidence score.

14. The non-transitory computer-readable medium of claim 7 wherein the predefined domain specific dataset comprises set of unique FAQ data related to the specific domain.

15. The non-transitory computer-readable medium of claim 7, wherein a set of positive and negative samples in equal ratio, is generated by a training engine, from the predefined domain specific dataset.

16. The non-transitory computer-readable medium of claim 7, wherein the validation comprises, similarity matching within the predefined domain specific dataset.

17. The non-transitory computer-readable medium of claim 7, wherein the accuracy of the configured model is calculated based on matching the predicted and the preset ground truth label on the predefined domain specific dataset.

18. The non-transitory computer-readable medium of claim 7, wherein assigning a confidence score to each entry in the predefined domain specific dataset is performed based on a prediction score from the learned model and a similarity score for each entry in the predefined domain specific dataset.
